(19) United States
(12) Patent Application Publication
(10) Pub. No.: US 2022/0119615 A1
(43) Pub. Date: Apr. 21, 2022

(54) FOAMED DIELECTRIC MATERIAL AND PRODUCTION METHOD THEREOF

(71) Applicant: Foshan Eahison Communication Co., Ltd., Foshan (CN)

(72) Inventors: Hongzhen ZHENG, Foshan (CN); Yongchao LU, Foshan (CN); Wei LI, Foshan (CN); Chunhui SHANG, Foshan (CN); Yaozhi SUN, Foshan (CN)

(21) Appl. No.: 17/617,484

(22) PCT Filed: Nov. 11, 2019
(86) PCT No.: PCT/CN2019/116952

§ 371 Date: Dec. 8, 2021

(30) Foreign Application Priority Data
Sep. 18, 2019 (CN) 201910875142.5

(51) Int. Cl. C08J 9/36

(52) U.S. Cl. CPC C08J 9/36; C08J 2323/06; C08J 2207/06

(57) ABSTRACT

The present disclosure discloses a foamed dielectric material, which is used to solve the problems of low production efficiency and high production cost of foamed dielectric materials at present. The foamed dielectric material is a cylinder structure or a tube structure formed by a foamed material after foaming; a plurality of gaps are cut on the surface of the cylinder structure or the tube structure, and the gap has a metal wire segment inside; and the metal wire segment in different gaps is not in contact with each other. The foamed dielectric material with such structure has the advantages such as a simple structure, an accurately controllable dielectric constant, light weight per unit volume, easy to efficiently product and stable technical index. The present disclosure further discloses a production method which may be used for producing the foamed dielectric material. In the production method, firstly a foamed rod-shaped part or a tubular part is passed through a slitting device, and passed through a buried wire device, and then truncated into a required length. The production method has the advantages such as high production efficiency, low cost, light weight and easy to control the dielectric characteristic.

### TECHNICAL FIELD

The present disclosure relates to the field of dielectric materials manufacturing, and in particular to a dielectric material processed by foamed materials for making Luneberg lenses and a production method thereof.

### BACKGROUND ART

The patent document, published as WO2009078807, entitled “AN ARTIFICIAL DIELECTRIC MATERIAL AND A METHOD OF MANUFACTURING THE SAME”, filed on Jun. 25, 2009, discloses an artificial dielectric material and a method of manufacturing the same. The artificial dielectric material may be used to manufacture Luneberg lenses. The technical scheme is mainly performed as follows: a long conductive fiber arranged in parallel is placed between upper and lower foamed materials, and after being bonded and fixed, the obtained slice with a sandwich structure is cut into particles, so that the obtained particles carry with short conductive fibers which are not in contact with each other, and the particles are randomly mixed and fixed together with an adhesive to prepare the dielectric material with a controlled dielectric constant.

However, the product and the manufacturing method described in above publication are actually flawed: because the size of the particles is very small, usually only a few square millimeters, when cutting the slice with a sandwich structure into particles, the cutting way used is basically the warp and weft tangent method, which leads to a relatively large amount of cutting work in the later stage, and a relatively high cutting accuracy requirement, and ultimately will lead to an increase in production cost.

Therefore, it is necessary to improve the structure and the manufacturing method of the existing dielectric materials.

### SUMMARY

The present disclosure provides a foamed dielectric material, which is used to solve the problems of low production efficiency and high production cost of foamed dielectric materials at present.

Particularly, the foamed dielectric material is a cylinder structure or a tube structure formed by a foamed material after foaming; a plurality of gaps are cut on the surface of the cylinder structure or the tube structure, and the gap has a metal wire segment inside; and the metal wire segment in different gaps is not in contact with each other.

In some embodiments, the foamed material is selected from the group consisting of EPE pearl cotton, EPS and EVA.

In some embodiments, the moving direction of the metal wire segment is along the longitudinal direction of the cylinder structure or the tube structure, or spiraling around the cylinder structure or the tube structure. At this time, it is equivalent to cutting a gap longitudinally on the surface of the cylinder structure or the tube structure, or cutting a gap spirally.

In some embodiments, the metal wire segment is regularly and evenly distributed. The regularity mentioned here is relative to an irregular and random distribution.

In some embodiments, the number of the metal wire segment is in a range of 2 to 8, and the diameter of the metal wire segment is in a range of 0.01-0.5 mm.

In the present disclosure, the peripheral contour shape of the cross section of the cylinder structure or the tube structure may be circular or regular polygon. Generally, the peripheral contour shape of the cross section of the cylinder structure or the tube structure does not exceed the range of a circle radius of 20 mm.

In the present disclosure, the length of the cylinder structure or the tube structure is generally not more than 20 mm.

The foamed dielectric material with such structure has the advantages such as a simple structure, an accurately controllable dielectric constant, light weight per unit volume, and especially in the case of the tube structure, it is easy to efficiently product, and has stable technical index. If such material is used in the production of Luneberg lenses, the production cost and weight of Luneberg lenses may be significantly reduced, playing a very positive role in the use and popularization of Luneberg lenses in communication antennas.

It should be noted that the important index of the dielectric material is dielectric constant, therefore, the foamed material used for the cylinder structure or the tube structure should select a material with a dielectric constant as low as possible. The number, material and diameter of the metal wire segment may be used to improve the dielectric constant, and these materials and/or parameters may be controlled artificially. Therefore, by setting these materials and/or parameters artificially, the dielectric constant of the produced foamed dielectric material may finally meet the target.

The present disclosure further provides a method for producing the foamed dielectric material, which is used to produce a dielectric material with light weight per unit volume efficiently and at low cost. The present disclosure provides the following technical schemes:

The method for producing the foamed dielectric material comprises:

1) passing a foamed rod-shaped part or a tubular part through a slitting device, and as the rod-shaped part or the tubular part passing through the slitting device, using the slitting device to cut a plurality of gaps on the surface of the rod-shaped part or the tubular part to obtain a rod-shaped part or a tubular part with a cut gap:

2) passing the rod-shaped part or the tubular part with a gap through a buried wire device, and as the rod-shaped part or the tubular part with a gap passing through the buried wire device, using the buried wire device to burry a metal wire into the gap to obtain a buried wire rod or a buried wire tube; and

3) subsequently, truncating the buried wire rod or the buried wire tube to a required length to obtain the foamed dielectric material.

Through the above steps, the linear rod-shaped part or the tubular part made by the existing processes may be made into a granular cylinder structure or tube structure with a metal wire segment inside, and such production method of a foamed dielectric material may realize a continuous production with very high production efficiency.

In order to further ensure that the metal wire in the buried wire rod or buried wire tube will not fall off by itself, after the above step 2), a surface coating or surface hot melting step may be added to fix the metal wire with the rod-shaped part or the tubular part together.

Because the physical positions of the slitting device and the buried wire device may be actually very close, it is considered to make the two devices into a slitting and buried wire device.

One of the structures of the slitting device may comprise a knife rest, wherein a through hole is formed on the knife rest, and a plurality of blades are fixed on the knife rest, and the cutting edges of the blades are extend into the through hole. In this way, when the rod-shaped part or the tubular part passes through the through hole of the slitting device, the rod-shaped part or the tubular part has to be cut by the cutting edge of the blade, and at this time, one blade will correspond to a slit. When the rod-shaped part or the tubular part passes through the slitting device only along its own central axis, the moving direction of the gap formed on its surface is longitudinal. When the rod-shaped part or the tubular part passes through the slitting device along its own central axis, while rotating relatively to the knife rest, the moving direction of the gap formed on the surface of the rod-shaped part or the tubular part is spiral.

One of the structures of the buried wire device may comprise a lead arm fixing frame, and the lead arm fixing frame is provided with a feeding hole, and a plurality of lead arms are fixed on the lead arm fixing frame, and the number and the distribution position of the lead arms are correspond to those of gaps on the surface of the rod-shaped part or the tubular part, and the pressing wire end of the lead arm are extended into the feeding hole. The lead arm fixing frame is further provided with a plurality of lead wire holes for limiting the position of a metal wire and guiding the direction of the metal wire. Each lead hole is correspondingly located near one lead arm. In this way, when the rod-shaped part or the tubular part passes through the feeding hole of the buried wire device, each gap of the rod-shaped part or the tubular part has to be temporarily opened by the pressing wire end of the corresponding lead arm, and then naturally closed after being buried in the metal wire.

By such technical scheme, the granular foamed dielectric material with a metal wire segment inside may be simply and efficiently prepared without cutting in warp and weft directions. Because such foamed dielectric material is improved on the existing conventional products, the process of the foamed dielectric material is easy to operate, and has low production cost and very light weight per unit volume. Moreover, the average dielectric constant of the final foamed dielectric material may be controlled by selecting the number, material and diameter of metal wires.

In the present disclosure, the rod-shaped part or the tubular part in the production method is selected from the group consisting of EPE pearl cotton, EPS and EVA.

In the present disclosure, the buried wire rod or the buried wire tube may be truncated into a same length at a fixed-length before step 3), or be integrally wound into a wire coil before step 3).

In the present disclosure, the production method of the foamed dielectric material has the advantages such as high production efficiency, low cost, light weight and easy to control the dielectric characteristic, and the prepared foamed dielectric material may be used for manufacturing Luneberg lenses.

### BRIEF DESCRIPTION OF THE DRAWINGS

FIG. 1 is a schematic diagram of the front view structure of the foamed dielectric material in Example 1.

FIG. 2 is a schematic diagram of the A-A section view structure of FIG. 1.

FIG. 3 is a schematic diagram of the front view structure of the foamed dielectric material in Example 2.

FIG. 4 is a schematic diagram of the B-B section view structure of FIG. 3.

FIG. 5 is a schematic diagram of the front view structure of the slitting device in Example 3.

FIG. 6 is a schematic diagram of the C-C section view structure of FIG. 5.

FIG. 7 is a schematic diagram of the front view structure of the buried wire device in Example 3.

FIG. 8 is a schematic diagram of the D-D section view structure of FIG. 7.

FIG. 9 is a working schematic diagram of the buried wire device in Example 3.

The description of the reference numbers. 1—foamed dielectric material; 11—gap; 12—metal wire segment; 2—foamed dielectric material; 21—gap; 22—metal wire segment; 23—square hole; 3—slitting device; 31—knife rest; 32—through hole; 33—blade; 4—buried wire device; 41—lead arm fixing frame; 42—feeding hole; 43—lead arm; 44—pressing wire end; 45—lead wire hole; 46—metal wire.

### DETAILED DESCRIPTION OF THE EMBODIMENTS

The the present disclosure will be further illustrated below with reference to the examples.

### Example 1

This example is an illustration of the structure of the foamed dielectric material according to the present disclosure.

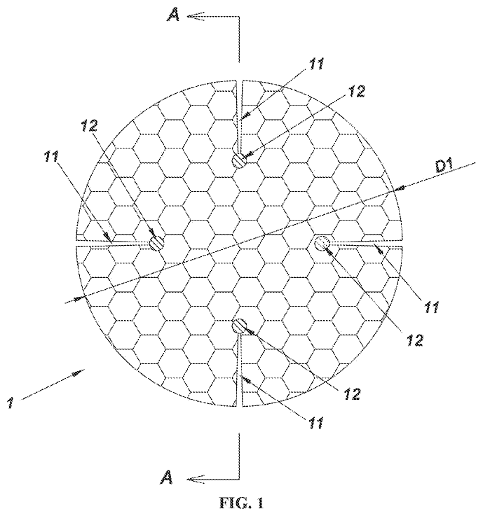

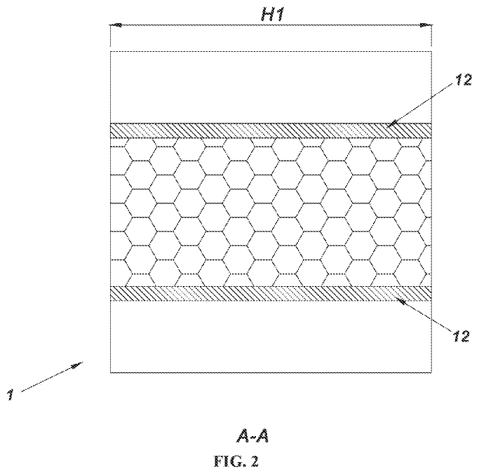

As shown in FIG. 1 and FIG. 2, the foamed dielectric material 1 in this example has a cylindrical structure. There are four gaps 11 along the longitudinal direction of the cylindrical structure cut on the side surface of the cylindrical structure. Each gap 11 has a metal wire segment 12 inside, and the metal wire segment 12 in different gaps 11 is not in contact with each other. In this example, the four gaps 11 are evenly distributed on the side surface of the cylinder structure. Because the moving direction of the gaps 11 is along the longitudinal direction of the cylinder structure and does not cross with each other, the moving direction of the metal wire segment 12 in the gap 11 is also in the longitudinal direction of the cylinder structure and does not in contact with each other.

In this example, the diameter D1 of the bottom surface of the cylindrical structure of the foamed dielectric material 1 is 5 mm, and the height H1 of the cylindrical structure of the foamed dielectric material 1 is also 5 mm.

The material of the cylinder structure in this example is EPE pearl cotton, that is, polyethylene foamed cotton.

### Example 2

The example is another illustration of the structure of the foamed dielectric material according to the present disclosure.

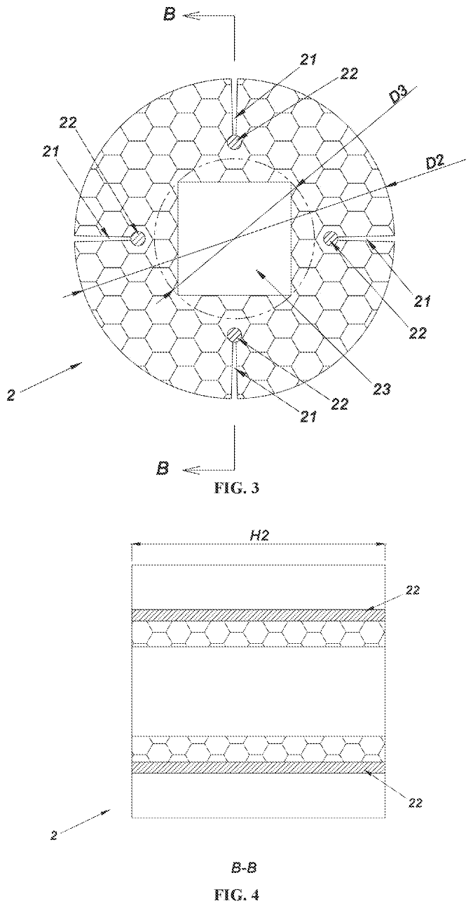

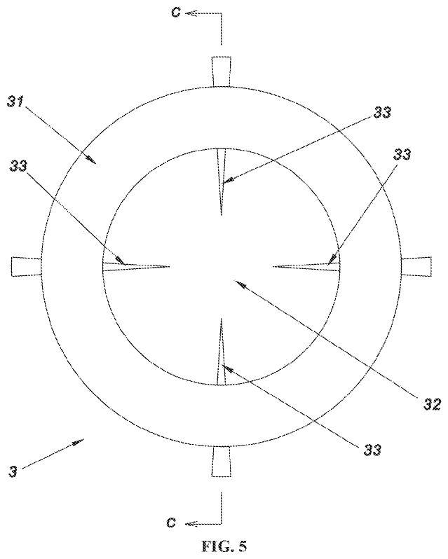

As shown in FIG. 3 and FIG. 4, the foamed dielectric material 2 in this example has a tube structure. There are four gaps 21 along the longitudinal direction of the tube structure cut on the side surface of the tube structure. Each gap 21 has a metal wire segment 22 inside, and the metal wire segments 22 in different gaps 21 is not in contact with each other. In this example, the four gaps 21 are evenly distributed on the side surface of the tube structure. Because the moving direction of the gaps 21 is along the longitudinal direction of the tube structure and does not cross each other, the moving direction of the metal wire segment 22 in the gap 21 is also in the longitudinal direction of the tube structure and does not in contact with each other.

In this example, the outer diameter D2 of the bottom surface of the tube structure of the foamed dielectric material 2 is 8 mm, and the height H2 of the tube structure is 6 mm. The inner hole is a square hole 23, and the diameter D3 of the circumscribed circle of the bottom surface of the square hole 23 is 0.625 times the outer diameter D2 of the bottom surface, that is, 5 mm. The four metal wire segments 22 each correspond to the four bottom edges of the square hole 23, and directly opposite the middle of these bottom edges.

The material of the tube structure in this example is EPE pearl cotton, that is, polyethylene foamed cotton.

### Example 3

This example is an illustration of the production method of the foamed dielectric material according to the present disclosure.

1) A foamed rod-shaped part with a diameter of 5 mm was passed through a slitting device 3. As shown in FIG. 5, the slitting device 3 in this example comprises a knife rest 31, wherein a through hole 32 is formed on the knife rest 31, and four blades 33 are fixed on the knife rest 31, and they are 900 to each other on a circumference. The cutting edges of the blades 33 are extended into the through hole 32. As the rod-shaped part passed through the slitting device 3 via the through holes 32, the slitting device 3 correspondingly cut four gaps on the surface of the rod-shaped part. Because the rod-shaped part only moved linearly along its own central axis, the moving direction of the four gaps cut on its surface naturally along the longitudinal direction of the rod-shaped part.

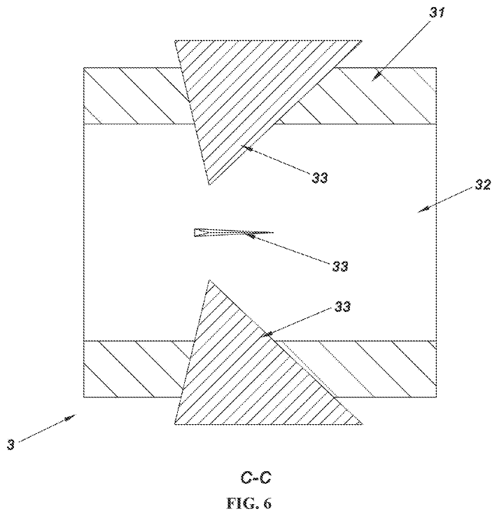

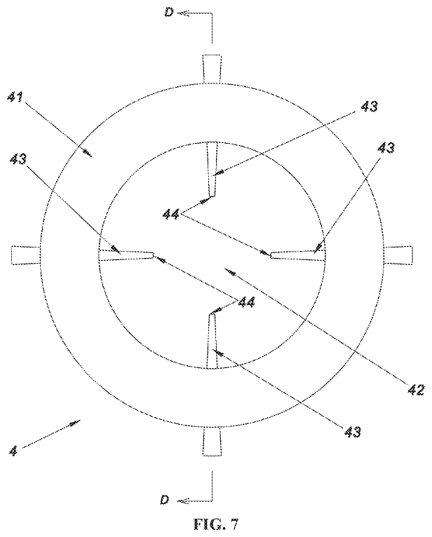

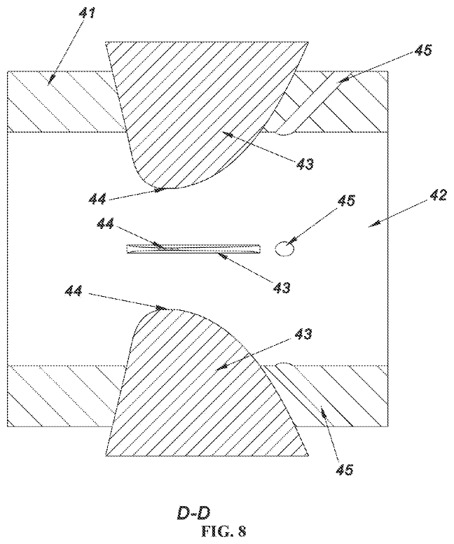

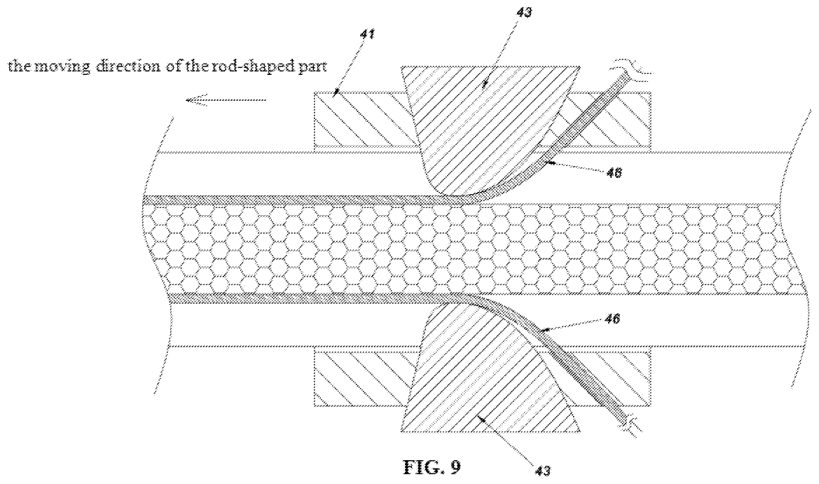

2) The rod-shaped part with a gap was passed through a buried wire device 4. As shown in FIG. 6, the buried wire device 4 in this example comprises a lead arm fixing frame 41, and the lead arm fixing frame 41 is provided with a feeding hole 42, and four lead arms 43 are fixed on the lead arm fixing frame 41, and they are 90° to each other on a circumference. The pressing wire end 44 of the lead arms 43 are extended into the feeding hole 42. The lead arm fixing frame 41 is further provided with a plurality of lead holes 45 for limiting the position of a metal wire 46 and guiding the direction of the metal wire 46. Each lead hole 45 is correspondingly located near one lead arm 43. As the rod-shaped part passed through the buried wire device 4 via the feeding hole 42, each gap of the rod-shaped part had to be temporarily opened by the pressing wire end 44 of the corresponding lead arm 43, while being buried in the metal wire 46 at the same time, and then naturally closed, obtaining the buried wire rod. The metal wire 46 of this example was put roll by four wire coils at the same time.

3) Subsequently, the buried wire rod was truncated into a cylindrical structure with a height of 5 mm with a fixed-length cutting machine, obtaining the foamed dielectric material with the structure described in example 1.

It should be noted that the rod-shaped part may have a short length, for example, with a length of 6 meters, before step 1), or may be integrally wound into a wire coil before step 1).

Similarly, if the rod-shaped part was integrally wound into a wire coil before step 1), the rod-shaped part with a gap obtained after step 1) may be truncated into a shorter length with a fixed-length cutting machine, for example, with a length of 6 meters, and then go to step 2), or directly go to step 2).

### Example 4

This example is another illustration of the production method of the foamed dielectric material according to the present disclosure.

The difference between this example and example 3 is that after obtaining the buried wire rod, a surface coating treatment or a surface hot melting treatment is also carried out to prevent the metal wire from falling off by itself from the gap.

The above examples in the specification are merely the description of the preferred embodiments of the present disclosure. Without departing from the working principle and idea of the present disclosure, the equivalent technical transformation should be regarded as the protection scope of the present disclosure.

1. A foamed dielectric material, wherein the foamed dielectric material is a cylinder structure or a tube structure formed by a foamed material after foaming; a plurality of gaps are cut on an outer surface of the cylinder structure or the tube structure, and each gap has a metal wire segment inside; and the metal wire segments in different gaps are not in contact with each other.

2. The foamed dielectric material of claim 1, wherein the foamed material is selected from the group consisting of EPE pearl cotton, EPS, and EVA.

3. The foamed dielectric material of claim 1, wherein a moving direction of at least one of the metal wire segment is along a longitudinal direction of the cylinder structure or the tube structure or spiraling around the cylinder structure or the tube structure.

4. The foamed dielectric material of claim 1, wherein the metal wire segment-arg regularly and evenly distributed.

5. The foamed dielectric material of claim 1, wherein the number of the metal wire segment is in a range of 2 to 8, and the diameter of at least one metal wire segment is in a range of 0.01-0.5 mm.

6. The foamed dielectric material of claim 1, wherein a peripheral contour shape of a cross section of the cylinder structure or the tube structure is circular or regular polygonal.

7. The foamed dielectric material of claim 1, wherein a peripheral contour shape of a cross section of the cylinder structure or the tube structure does not exceed a range of a circle radius of 20 mm.

8. A method for producing the foamed dielectric material, comprising:
1) passing a foamed rod-shaped part or a tubular part through a slitting device, and as the rod-shaped part or the tubular part is passing through the slitting device, using the slitting device to cut a plurality of gaps on an outer surface of the rod-shaped part or the tubular part to obtain a rod-shaped part or a tubular part with a cut gap;
2) passing the rod-shaped part or the tubular part with a gap through a buried wire device, and as the rod-shaped part or the tubular part with a gap is passing through the buried wire device, using the buried wire device to embed a metal wire into the gap to obtain a buried wire rod or a buried wire tube; and
3) subsequently, truncating the buried wire rod or the buried wire tube to a required length to obtain the foamed dielectric material.

9. The production method of claim 8, wherein after step 2), a surface coating or surface hot melting step is added to fix the metal wire to the rod-shaped part or the tubular part together.

10. The production method of claim 8, wherein the buried wire rod or the buried wire tube is truncated into a same length at a fixed-length before step 3), or is integrally wound into a wire coil before step 3).

11. The foamed dielectric material of claim 3, wherein the metal wire segments are regularly and evenly distributed.

12. The foamed dielectric material of claim 5, wherein a peripheral contour shape of a cross section of the cylinder structure or the tube structure is circular or regular polygonal
